(19) United States
(12) Patent Application Publication
(10) Pub. No.: US 2001/0046231 A1
(43) Pub. Date: Nov. 29, 2001

(54) Communication control apparatus

(76) Inventor: Masahide Hirasawa, Kanagawa (JP)

Correspondence Address: ROBIN, BLECKER & DALEY, 330 Madison Ave., New York, NY, 10017, US

(21) Appl. No.: 09/837,055

(22) Filed: Apr. 18, 2001

(30) Foreign Application Priority Data
Apr. 20, 2000 (JP) 119029/2000

(51) Int. Cl. H04L 12/28

(52) U.S. Cl. 370/389; 370/252

(57) ABSTRACT

A communication control apparatus divides a network conforming to the IEEE 1394-1995 Standard into a segment A and a segment B. and controls the relaying of an isochronous packet that has been transmitted from a node belonging to the segment A in accordance with the AV protocol. If an all-prohibition mode has been set, the communication control apparatus prohibits the relaying of an isochronous packet that has been transmitted from any one of the nodes belonging to the segment A. On the other hand, if the all-prohibition mode has not been set, the communication control apparatus prohibits the relaying of an isochronous packet that has been transmitted from a predetermined node belonging to the segment A in accordance with the AV protocol.

### BACKGROUND OF THE INVENTION

1. Field of the Invention

The present invention relates to an apparatus for enhancing the security and secrecy of data to be transmitted in accordance with an isochronous transfer mode.

2. Description of Related Art

In recent years, the IEEE 1394-1995 Standard has been known as one of the techniques for implementing a digital interface to transmit/receive digital video data and/or digital audio data between a plurality of electronic apparatuses.

The IEEE 1394-1995 Standard is one of the standards for implementing a high-performance serial bus, and is provided with a transfer mode (transfer scheme) that is so called as an isochronous transfer mode. The isochronous transfer mode is a transfer mode which ensures the transfer (transmission) of data in a predetermined size for every one communication cycle (one communication cycle being approximately 125 μsec.), and is suitable for the transmission/reception of the data that places special emphasis on a real-time property, such as video data and audio data. The isochronous transfer mode is also a transfer mode in which an address is not specified, and thus the data that is transmitted from a certain node in the isochronous transfer mode is broadcast to all nodes over a network.

Further, in recent years, the IEC 61883 Standard has been known as one of the communication protocols in which the isochronous transfer mode of the IEEE 1394-1995 Standard is used. The IEC 61883 Standard is a communication protocol (hereinafter, referred to as “AV protocol”) for transmitting/receiving digital video data and/or digital audio data (hereinafter, referred to as “digital AV data”). A configuration of an isochronous packet that is defined with the AV protocol is shown in FIG. 10. In FIG. 10, reference numeral 1001 denotes a header in which channel numbers and the like are stored. Reference numeral 1002 denotes a CRC (header CRC) for checking an error in the header 1001. Reference numeral 1003 denotes a data field. Reference numeral 1004 denotes a CRC (data CRC) for checking an error in the data field 1003. Reference numeral 1005 denotes a CIP (common isochronous packet) header that is defined in the IEC 61883 Standard. Reference numeral 1006 denotes a field in which node IDs of transmitting ends (source nodes) are stored. Reference numeral 1007 denotes AV data that conforms to a predetermined data format (e.g., the SD format in the DV Standard, the MPEG-2 TS (transport stream) in the MPEG Standard).

However, when transmitting data in accordance with the isochronous transfer mode, there is a problem that the security and secrecy of the data can not be secured because the data is broadcast to all nodes over the network. Similarly, when transmitting digital AV data in accordance with the above-described AV protocol, there is a problem that the security and secrecy of the digital AV data can not be secured because the digital AV data is broadcast to all nodes over the network.

### BRIEF SUMMARY OF THE INVENTION

Accordingly, it is an object of the present invention to provide an apparatus for enhancing the security and secrecy of data to be transmitted in accordance with an isochronous transfer mode.

To attain the above object, in accordance with an aspect of the present invention, there is provided a communication control apparatus for dividing one network into a first segment and a second segment, comprising a first port connected to the first segment, a second port connected to the second segment, and control means for providing such a control as to, when a predetermined condition is satisfied, cause an isochronous packet received by the first port not to be relayed to the second port.

Preferably, when providing such a control as to cause an isochronous packet received by the first port not to be relayed to the second port, the control means provides such a control as to replace the isochronous packet received by the first port with another isochronous packet and then to relay the above-mentioned another isochronous packet to the second port.

More preferably, the above-mentioned another isochronous packet is an isochronous packet which includes dummy data or null data.

Further, preferably, when the isochronous packet received by the first port is an isochronous that has been transmitted from a predetermined node in accordance with an AV protocol, the control means provides such a control as to cause the isochronous packet received by the first port not to be relayed to the second port.

Preferably, when a mode in which an isochronous packet transmitted from any node that belongs to the first segment is prevented from being relayed to the second port is set, the control means provides such a control as to cause the isochronous packet received by the first port not to be relayed to the second port.

Further, preferably, the network is a network conforming to the IEEE 1394-1995 Standard.

Still other objects of the present invention, and the advantages thereof, will become fully apparent from the following detailed description of the preferred embodiments thereof taken in conjunction with the accompanying drawings.

### BRIEF DESCRIPTION OF THE SEVERAL VIEWS OF THE DRAWINGS

FIG. 1 is a view showing one structural example of a communication network according to an embodiment of the present invention.

FIG. 2 is a block diagram illustrating the main structure of a communication control apparatus 100.

FIG. 3 is a flowchart illustrating a procedure for registering a node for which the relaying of an isochronous packet transmitted in accordance with the AV protocol is prohibited.

FIG. 4 is a flowchart showing a procedure for updating the content of a list.

FIG. 5 is a flowchart illustrating a procedure for controlling the relaying of an isochronous packet transmitted in accordance with the AV protocol.

FIGS. 6(A) and 6(B) are diagrams showing one example of the list.

FIG. 7 is a view showing a topology map of the segment A to be displayed when the name of each apparatus and the permission/prohibition of the relaying for each node are registered.

FIG. 8 is a view showing a window for registering the name of each apparatus and the permission/prohibition of the relaying.

FIG. 9 is a view showing a topology map of the segment A to be displayed after the name of each apparatus and the permission/prohibition of the relaying for all nodes are registered.

FIG. 10 is a view showing an isochronous packet that is defined with the AV protocol.

### DETAILED DESCRIPTION OF THE INVENTION

Hereinafter, preferred embodiments of the present invention will be described in detail with reference to the drawings.

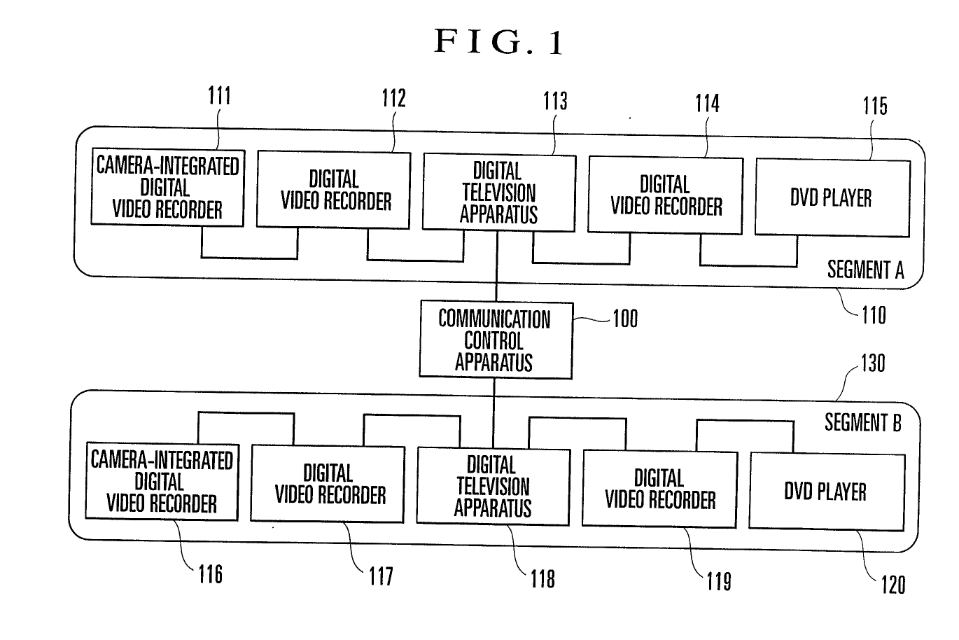

FIG. 1 shows one structural example of a communication network conforming to the IEEE 1394-1995 Standard.

In FIG. 1, reference numeral 100 denotes a communication control apparatus for dividing one communication network into a plurality of segments that are independent from one another. Reference numeral 110 denotes a first segment (hereinafter, referred to as “segment A”). As shown in FIG. 1, nodes 111 to 115 are connected to the segment A. Reference numerical 120 denotes a second segment (hereinafter, referred to as “segment B”). As shown in FIG. 1, nodes 116 to 120 are connected to the segment B.

Also, in FIG. 1, the node 111 represents a camera-integrated digital video recorder (hereinafter, referred to as “video camera”). The nodes 112 and 114 represent digital video recorders (hereinafter, referred to as “video recorders”). The node 113 represents a digital television apparatus (hereinafter, referred to as “TV”) for receiving and displaying a digital television broadcast corresponding to a predetermined channel number. The node 115 represents a DVD player for reproducing a DVD (Digital Versatile Disc) on which digital AV data is recorded.

Further, in FIG. 1, the node 116 represents a camera-integrated digital video recorder (hereinafter, referred to as “video camera”). The nodes 117 and 119 represent digital video recorders (hereinafter, referred to as “video recorder”). The node 118 represents a digital television apparatus (hereinafter, referred to as “TV”) for receiving and displaying a digital television broadcast corresponding to a predetermined channel number. The node 120 represents a DVD player for reproducing a DVD (Digital Versatile Disc) on which digital AV data is recorded.

Each of the nodes 111 to 120 is able to transmit digital AV data conforming to a predetermined format (an SD format of the DV Standard, an SDL format of the same Standard, an HD format of the same Standard, or an MPEG-2 TS (transport stream) of the MPEG Standard) to other nodes, in accordance with the communication protocol conforming to the IEC 61883 Standard (i.e., the AV protocol).

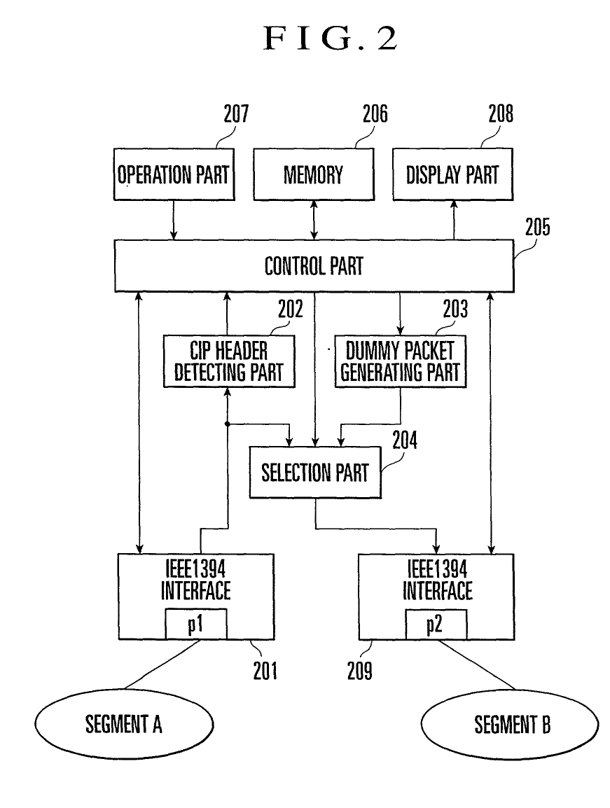

Then, referring to FIG. 2, the main structure of the communication control apparatus 100 will be described.

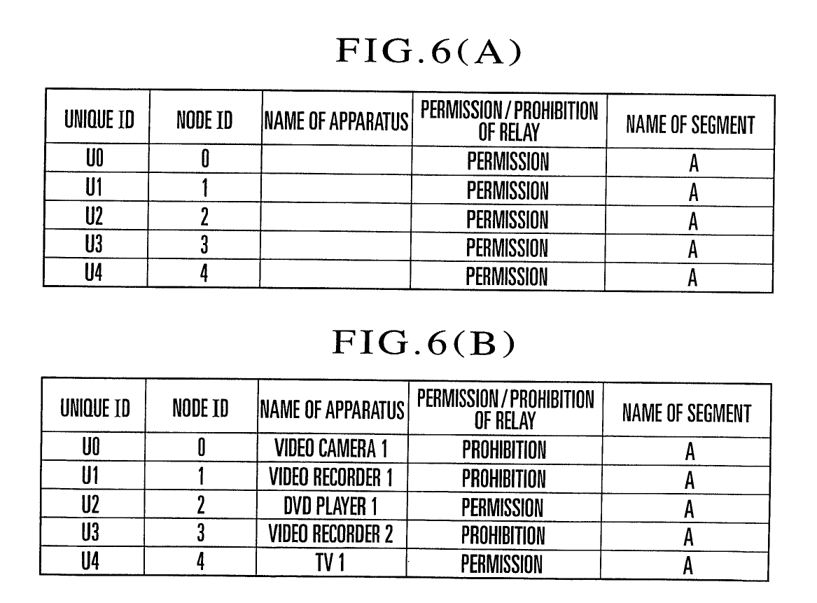

In FIG. 2, reference numerals 201 and 209 denote digital interfaces (hereinafter, referred to as “IEEE 1394 interfaces”) conforming to the IEEE 1394-1995 Standard. The IEEE 1394 interface 201 is provided with a port p1, and the IEEE 1394 interface 209 is provided with a port p2. The segment A is, as shown in FIG. 2, connected to the port p1. Also, the segment B is, as shown in FIG. 2, connected to the port p2. Reference numeral 202 denotes a CIP (common isochronous packet) header detecting part for detecting a CIP header defined with the IEC 61883 Standard from an isochronous packet received by the port p1. Reference numeral 205 denotes a control part provided with a microcomputer and a memory. Reference numeral 203 denotes a dummy packet generating part for generating an isochronous packet (hereinafter, referred to as “dummy packet”) that includes dummy data (instead of the dummy data, it may be empty data or null data). Reference numeral 204 denotes a selection part for selecting and outputting either the isochronous packet received by the port pl or the dummy packet generated by the dummy packet generating part 203, in accordance with an instruction from the control part 205. Reference numeral 206 denotes a memory for holding a list in which unique IDs, node IDs, apparatus names and the permission/prohibition of the relaying, segments to which they belong, of the nodes 111 to 115 are stored. An example of the list held by the memory 206 is shown in FIGS. 6(A) and 6(B). Reference numeral 207 denotes an operation part. Reference numeral 208 denotes a display part.

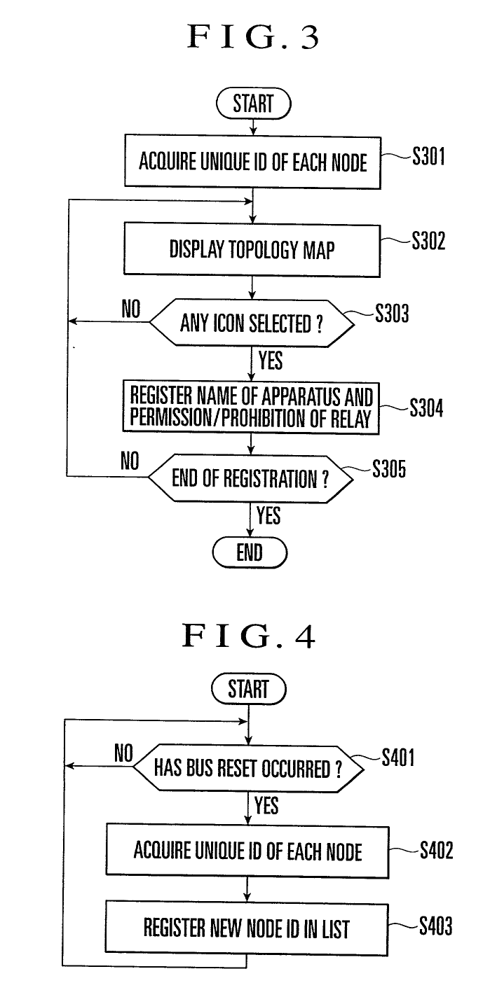

In the following, referring to FIG. 3, a procedure for registering a node that transmits an isochronous packet which is not desirable to be relayed from the segment A to the segment B.

In step S301, the control part 205 acquires a node ID (6 bits) and a unique ID (64 bits) of each node that belongs to the segment A, and creates a list as shown in FIG. 6 (A).

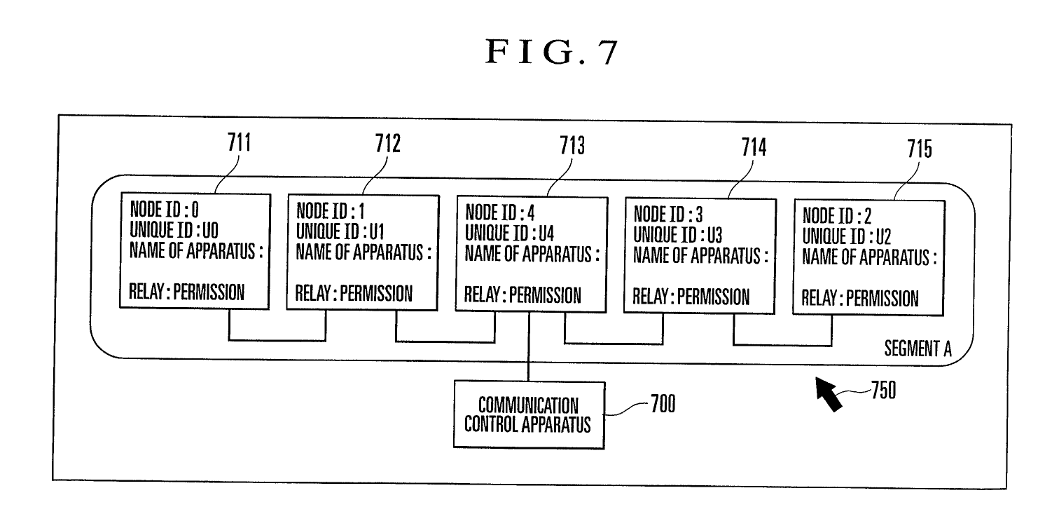

In step S302, the control part 205 creates a topology map of the segment A, and displays it on the display part 208. An example of the topology map is shown in FIG. 7. In FIG. 7, reference numeral 700 denotes display information (hereinafter, referred to as “icon”) that represents the communication control apparatus 100. Reference numerals 711 to 715 denote display information (hereinafter, referred to as “icons”) that represent the nodes 111 to 115 that belong to the segment A. In each of the icons 711 to 715, as shown in FIG. 7, there are displayed a unique ID, an apparatus name, and the permission/prohibition of the relaying. Further, the apparatus name will be displayed on the icon after it is registered. Also, the permission/prohibition of the relaying is displayed as a “Permission” since the “Permission” is selected as a default.

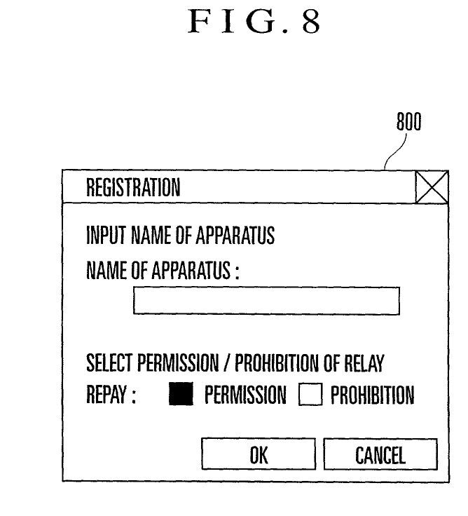

The user operates a cursor 750 through the operation part 207 to select an icon that corresponds to a desirable node, among the icons 711 to 715. When the icon is selected, the present flowchart proceeds to step S303. In the step s303, the control part 205 displays a window 800 shown in FIG. 8 on the display part 208.

After the window 800 has been displayed, the user inputs an apparatus name of the desirable node, through the operation part 207. For example, if it is desirable to register an apparatus name “DVD Player 1” of the DVD player 115 that belongs to the segment A, the user needs to select the icon 715 in the step S303 and to input the apparatus name as “DVD Player 1”.

Then, the user selects, through the operation part 207, either to permit relaying the isochronous packet transmitted in accordance with the AV protocol to another segment, or to prohibit it. When permitting the relaying, an item “Permission” should be checked, but when prohibiting the relaying, then an item “Prohibition” should be checked. For instance, if it is desirable not to relay the isochronous packet outputted from the DVD player 115 that belongs to the segment A to the segment B, then the user needs to select the icon 715 in the step S303 and to check the item “Prohibition”. After having inputted the apparatus name of the desirable node and having selected the permission/prohibition of the relaying, the user presses down an item “OK” to register the above information. When the item “OK” is pressed down, the present flowchart proceeds to step S304. In the step S304, the control part 205 registers the apparatus name and the permission/prohibition of the relaying in the list shown in FIG. 6 (A), and displays the registered information on the topology map.

In step S305, the control part 205 determines whether the apparatus names and the permission/prohibition of the relaying of all the nodes 111 to 115 have been registered or not. If the apparatus names and the permission/prohibition of the relaying of all the nodes 111 to 115 have been registered, the control part 205 asks the user whether the registering operation should be completed. If the registering operation should be completed, then the present flowchart is terminated.

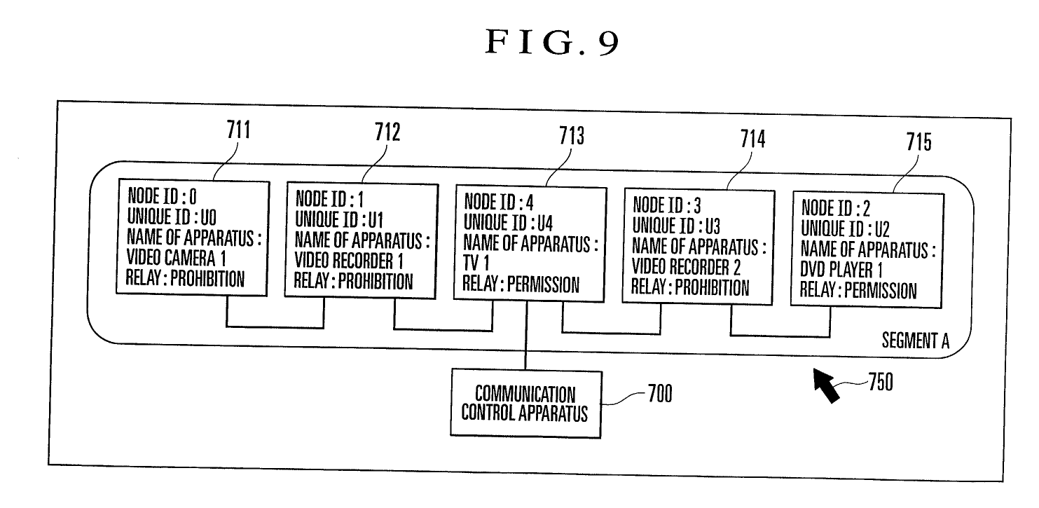

An example of the list after the apparatus names and the permission/prohibition of the relaying of all the nodes 111 to 115 have been registered is shown in FIG. 6(B), and an example of the topology map is shown in FIG. 9. As shown in FIG. 6 (B) and FIG. 9, in the present embodiment, the nodes 111, 112 and 114 are registered as the nodes for which the relaying is prohibited, and the nodes 113 and 115 are registered as the nodes for which the relaying is permitted.

According to the procedures described above, the nodes for which it is desirable not to relay data from the segment A to the segment B can be easily registered. Also, the node ID, the apparatus name, and the permission/prohibition of the relaying of each of the nodes 111 to 115 can be registered as being associated with the unique IDs.

In the IEEE 1394-1995 Standard, in a case where a bus reset has occurred, the unique ID of each node does not change, but the node ID allocated to each node changes. Therefore, in a case where a bus reset has occurred, the node IDs registered in the list shown in FIG. 6 (B) must be updated. In the following, a procedure for automatically updating the node IDs registered in the list shown in FIG. 6 (B), which is effected by the communication control apparatus 100 in the present embodiment, will be described with reference to the flowchart of FIG. 4.

In step S401, the control part 205 determines whether the bus reset has occurred or not. If the bus reset has occurred, then all of the nodes 111 to 115 initialize the node IDs and the information (hereinafter, referred to as “topology information”) relating to the topology of the network, and then acquire new node IDs and new topology information in accordance with the procedures defined in the IEEE 1394-1995. When the occurrence of the bus reset has been detected, the present flowchart proceeds to step S402.

In the step S402, the control part 205 acquires unique IDs of all the nodes 111 to 115 for every node ID.

In step S403, the control part 205 detects the new node IDs of the respective nodes 111 to 115, and registers them in the list shown in FIG. 6(B). Herein, if a unique ID that is not registered in the list is detected, then the communication control apparatus 100 registers that unique ID and a segment to which a node corresponding to that unique ID belongs into the list. Further, for the permission/prohibition of the relaying, the communication control apparatus 100 selects and registers “Permission”.

According to the procedures described above, even if the bus reset occurs, since it is possible for the communication control apparatus 100 to automatically detect the new node IDs of the respective nodes and to register them in the list, it is no longer necessary to ask the user to create the list for every bus reset, thereby making it possible to reduce the burden of the user.

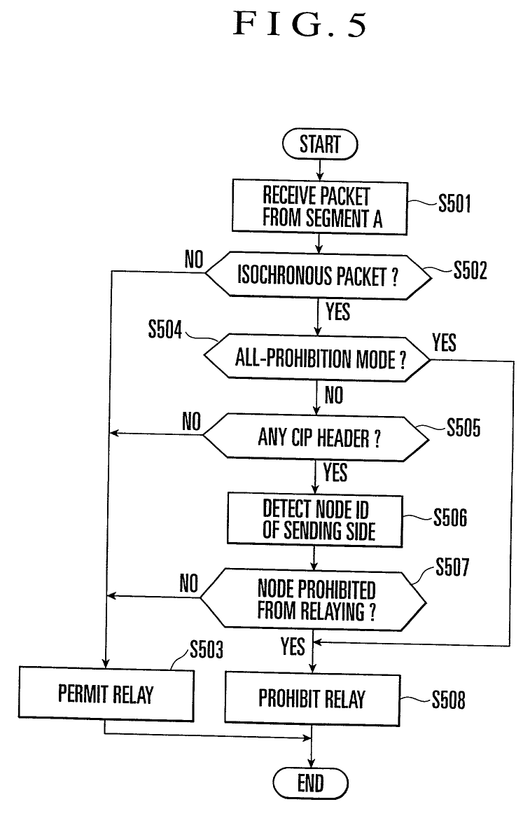

In the following, referring to FIG. 5, a procedure for controlling the relaying of an isochronous packet that has been transmitted from a node belonging to the segment A in accordance with the AV protocol will be described.

In step S501, the port p1 receives a packet transmitted from a node belonging to the segment A.

In step S502, the IEEE 1394 Interface 201 determines whether the packet received in the step S501 is an isochronous packet or not. Further, whether or not the packet received by the port p1 is an isochronous packet is, for example, determined on the basis of the length of a gap (for more details, it is defined in the IEEE 1394-1995 Standard). If it is not the isochronous packet, but is an asynchronous packet, then the present flowchart proceeds to step S503. On the other hand, if it is the isochronous packet, then the present flowchart proceeds to step S504.

In the step S503, the control part 205 permits the relaying. Thus, the control part 205 controls the selection part 204 so as to relay the asynchronous packet received by the port p1 to the port p2. That is, the communication control apparatus 100 can relay the asynchronous packet from the segment A to the segment B.

In the step S504, the control part 205 determines whether an all-prohibition mode (a mode in which the relaying of the isochronous packet transmitted from any node that belongs to the segment A is prohibited) has been set. If the all-prohibition mode has not been set, then the present flowchart proceeds to step S505. On the other hand, if the all-prohibition mode has been set, then the present flowchart proceeds to step S508. In the step S508, the control part 205 prohibits the relaying of the isochronous packet. In this instance, the control part 205 controls the selection part 204 so as to supply a dummy packet generated in the dummy packet generating part 203 to the port p2. That is, when the all-prohibition mode has been set, the communication control apparatus 100 replaces the isochronous packet with the dummy packet, and then relays the dummy packet to the segment B. Incidentally, the all-prohibition mode is assumed to be set by the user through the operation part 207.

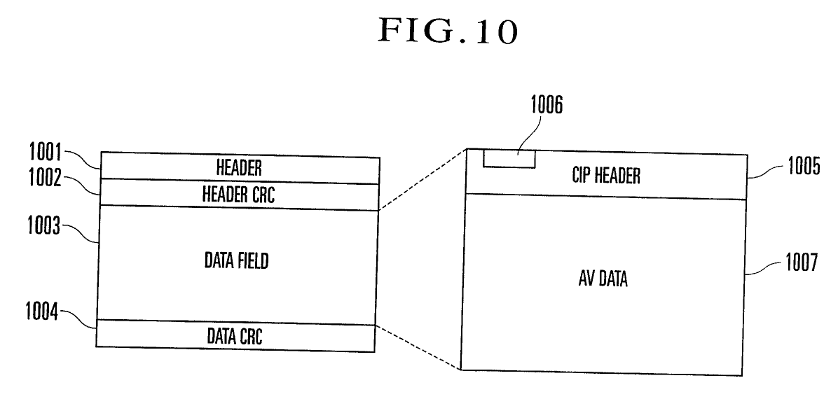

In the step S505, the CIP header detecting part 202 detects the CIP header from the isochronous packet received in the step S501. The isochronous packet that has been transmitted in accordance with the AV protocol includes the CIP header, as shown in FIG. 10. Accordingly, by detecting the presence or absence of the CIP header, the communication control apparatus 100 can determine whether or not the isochronous packet received by the port p1 is the isochronous packet that has been transmitted in accordance with the AV protocol. If the CIP header has been detected (i.e., if it is determined that the isochronous packet has been transmitted in accordance with the AV protocol), then the CIP header detecting part 202 supplies the CIP header to the control part 205. On the other hand, if the CIP header has not been detected (i.e., if it is determined that the isochronous packet has been transmitted in accordance with a communication protocol other than the AV protocol), then the present flowchart proceeds to the step S503. In the step S503, the control part 205 permits the relaying. That is, the communication control apparatus 100 can relay the isochronous packet that has been transmitted in accordance with the communication protocol other than the AV protocol, to the segment B.

In step S506, the control part 205 detects the node ID of the transmitting end (source node) from the CIP header.

In step S507, the control part 205 searches (retrieves) the list shown in FIG. 6(B) to determine whether or not the node of the transmitting end is a node for which the relaying is prohibited. If it is a node for which the relaying is permitted, the present flowchart proceeds to the step S503. In the step S503, the control part 205 permits the relaying. That is, the communication control apparatus 100 can relay the isochronous packet that has been transmitted from the node for which the user has permitted the relaying in advance in accordance with the AV protocol, to the segment B.

On the other hand, if it is the node for which the relaying has been prohibited, the present flowchart proceeds to step S508. In the step S508, the control part 205 prohibits the relaying of the isochronous packet. In this instance, the control part 205 controls the selection part 204 to supply the dummy packet generated by the dummy packet generating part 203 to the port p2. That is, when receiving the isochronous packet that has been transmitted from the node for which the user has prohibited the relaying in advance, the communication control apparatus 100 replaces that isochronous packet with the dummy packet and relays the dummy packet to the segment B.

As described above, according to the communication control apparatus 100 in the present embodiment, since one network is divided into the segment A and segment B, and the relaying from the segment A to the segment B about the isochronous packet that has been transmitted in accordance with the AV protocol is limited in accordance with a predetermined condition, it is possible to enhance the security and secrecy of the isochronous packet that has been transmitted in accordance with the AV protocol.

Also, according to the communication control apparatus 100 in the present embodiment, if the all-prohibition mode has been set, it is possible to prevent an isochronous packet that has been transmitted from any node belonging to the segment A from being relayed from the segment A to the segment B.

Further, according to the communication control apparatus 100 in the present embodiment, when the isochronous packet is not relayed from the segment A to the segment B, since the dummy packet is transmitted instead of the isochronous packet, it is possible to limit the relaying of the isochronous packet with an easy and simple structure without disturbing the communication cycle defined in the IEEE 1394-1995 Standard.

The invention may be embodied in other specific forms without departing from essential characteristics thereof.

In the present embodiment, the case of limiting the relaying of the isochronous packet that has been transmitted in accordance with the AV protocol from the segment A to the segment B has been described, but the present invention is not limited to this case. The present invention can also apply to the case of limiting the relaying of the isochronous packet that has been transmitted in accordance with the AV protocol from the segment B to the segment A.

Also, in the present embodiment, the case of dividing one network into two segments has been described, but the present invention is not limited to this case. The present invention can also apply to the case of dividing one network into two or more segments.

Further, in the present embodiment, the case of dividing the network conforming to the IEEE 1394-1995 Standard into a plurality of segments, but the present invention is not limited to this case. The present invention can also apply to the case of dividing the network conforming to the Extended Standards (the IEEE 1394a-2000 Standard, and the like, the IEEE P1394.b Standard) of the IEEE 1394-1995 Standard into a plurality of segments.

Therefore, the above-mentioned embodiments are merely examples in all respects, and must not be construed to limit the invention.

The scope of the present invention is defined by the scope of the appended claims, and is not limited at all by the specific descriptions of this specification. Furthermore, all the modifications and changes belonging to equivalents of the claims are considered to fall within the scope of the present invention.

1. A communication control apparatus for dividing one network into a first segment and a second segment, comprising:
a first port connected to said first segment;
a second port connected to said second segment; and
control means for providing such a control as to, when a predetermined condition is satisfied, cause an isochronous packet received by said first port not to be relayed to said second port.

2. A communication control apparatus according to claim 1, wherein, when providing such a control as to cause an isochronous packet received by said first port not to be relayed to said second port, said control means provides such a control as to replace the isochronous packet received by said first port with another isochronous packet and then to relay said another isochronous packet to said second port.

3. A communication control apparatus according to claim 2, wherein said another isochronous packet is an isochronous packet which includes dummy data or null data.

4. A communication control apparatus according to claim 1, wherein, when the isochronous packet received by said first port is an isochronous that has been transmitted from a predetermined node in accordance with an AV protocol, said control means provides such a control as to cause the isochronous packet received by said first port not to be relayed to said second port.

5. A communication control apparatus according to claim 4, wherein, when providing such a control as to cause an isochronous packet received by said first port not to be relayed to said second port, said control means provides such a control as to replace the isochronous packet received by said first port with another isochronous packet and then to relay said another isochronous packet to said second port.

6. A communication control apparatus according to claim 5, wherein said another isochronous packet is an isochronous packet which includes dummy data or null data.

7. A communication control apparatus according to claim 1, wherein, when a mode in which an isochronous packet transmitted from any node that belongs to said first segment is prevented from being relayed to said second port is set, said control means provides such a control as to cause the isochronous packet received by said first port not to be relayed to said second port.

8. A communication control apparatus according to claim 7, wherein, when providing such a control as to cause an isochronous packet received by said first port not to be relayed to said second port, said control means provides such a control as to replace the isochronous packet received by said first port with another isochronous packet and then to relay said another isochronous packet to said second port.

9. A communication control apparatus according to claim 8, wherein said another isochronous packet is an isochronous packet which includes dummy data or null data.

10. A communication control apparatus according to claim 1, wherein said network is a network conforming to the IEEE 1394-1995 Standard.
